(19) United States
(12) Patent Application Publication
(10) Pub. No.: US 2015/0324820 A1
(43) Pub. Date: Nov. 12, 2015

(54) INFERRING USER DEMOGRAPHIC INFORMATION FROM RATINGS

(71) Applicants: Stratis IOANNIDIS, San Francisco, CA (US); Udi WEINSBERG, Menlo Park, CA (US); Smiriti BHAGAT, San Francisco, CA (US); THOMSON LICENSING, Issy Les Moulineaux (FR)

(72) Inventors: Stratis Ioannidis, San Francisco, CA (US); Udi Weinsberg, Menlo Park, CA (US); Smiriti Bhagat, San Francisco, CA (US)

(21) Appl. No.: 14/652,209

(22) PCT Filed: Dec. 12, 2013
(86) PCT No.: PCT/US13/74662

§ 371 Date: Jun. 15, 2015

Related U.S. Application Data
(60) Provisional application No. 61/737,742, filed on Dec. 15, 2012.

(51) Int. Cl. G06Q 30/02

(52) U.S. Cl. CPC G06Q 30/0204; G06Q 30/0282

(57) ABSTRACT

Existing recommendation systems leverage user social and demographic information, e.g., age, gender and political affiliation, to personalize content and make recommendations. However, users do not volunteer this information due to privacy concerns or to the lack of initiative in filling out their profile information. The current methods and apparatus provide principles in which the system may learn the private attribute for those users who do not voluntarily disclose them. In an exemplary embodiment, the system receives ratings for items, such as movies, for example, that may be used by a recommendation system. The inventive arrangements are based on novel usage of Bayesian matrix factorization in an active learning setting. Such a system can be carried out using significantly fewer rated items than previously proposed static inference methods. The system functions effectively without sacrificing the quality of the regular recommendations made to the user.

### CROSS-REFERENCE TO RELATED APPLICATIONS

This application claims the benefit of U.S. Provisional Application Ser. No. 61/737742, filed Dec. 15, 2012, which is incorporated by reference herein in its entirety.

### TECHNICAL FIELD

The present principles relate to apparatus and methods for generating demographic information from user ratings.

### BACKGROUND OF THE INVENTION

Demographic information has been used by advertisers and program providers to target their message or content to as many relevant users as possible. But demographics can also be used by recommendation systems that exist to help users find a choice in programming, shopping, events, etc. These recommendation systems rely on user demographics to generate recommended choices to users for products, movies, events, restaurants, shopping and other such activities. But often users are reluctant to voluntarily share their demographic information.

Many recommendation systems today rely on user ratings to understand their user's interests and to recommend new products and events to them. Knowing the demographic information of a user can be valuable not only in improving recommendations, but also for deciding which advertisements to show to the user, for example, for marketing purposes.

Sometimes, users are asked to enter their demographic information by way of surveys. But many users are wary of their privacy to such an extent that they give inaccurate or vague responses, if they reply at all. Often, users have little initiative to fill out survey or profile forms. Therefore, a need exists for recommendation systems to be able to learn, or infer, user demographic information in other ways. Recommendation systems rely on knowing not just their users' preferences (i.e., ratings on items), but also their social and demographic information, e.g., age, gender, political affiliation, and ethnicity. A rich user profile allows a recommendation system to better personalize its service, and at the same time enables additional monetization opportunities, such as targeted advertising.

Users of a recommendation system know they are disclosing their preferences (or ratings) for movies, books, or other items (throughout this description, movies are used as a running example). In order for a recommendation system to obtain additional social and demographic information about its users, it can choose to explicitly ask users for this information. While some users may willingly disclose it, others may be more privacy-sensitive and may explicitly elect not volunteer any information beyond their ratings. Users are increasingly becoming privacy conscious.

Standard classification methods have been proposed to infer gender from ratings. These involve treating the ratings a user gives to movies as a “feature vector”, which is subsequently fed into a standard classifier (e.g., logistic regression, support vector machines, etc.) One problem with standard classification methods is that these methods ignore the nature of the input to the classification. For example, user ratings have been shown to follow a linear relationship.

The present invention addresses the issues of determining demographic information from user ratings. The present principles can be used to provide improvement in recommendation systems and in allowing a targeting advertising application to determine which ads are to be shown to a user. The present invention exploits the linear relationship of user ratings to build a classifier that outperforms the standard methods.

### SUMMARY OF THE INVENTION

These and other drawbacks and disadvantages of the prior art are addressed by the present principles, which are directed to methods and apparatus for generating demographic information from user ratings. From the demographic information, improved recommendations for products, services, and advertisements can be provided.

According to an aspect of the present principles, there is provided a method and an apparatus for generating demographic information from user ratings. The method comprises accessing information in a set, generating a profile matrix by matrix factorization for each of a plurality of items in the set relating to demographic information, receiving at least one rating the user has assigned to at least one of the plurality of items in said set and finding a solution to a system of linear equations based on the at least one rating from the user and the profile matrix to generate demographic information regarding the user.

According to another aspect of the present principles, there is provided an apparatus for generating demographic information from user ratings. The apparatus comprises one or more processors for determining demographic information of a user, collectively configured to access information in a set, generate a profile matrix by matrix factorization for each of a plurality of items in the set relating to demographic information, receive at least one rating the user has assigned to at least one of the plurality of items in the set, and find a solution to a system of linear equations based on the at least one rating from the user and the profile matrix to generate demographic information regarding the user.

These and other aspects, features and advantages of the present principles will become apparent from the following detailed description of exemplary embodiments, which are to be read in connection with the accompanying drawings.

### BRIEF DESCRIPTION OF THE DRAWINGS

FIG. 1 shows one embodiment of a method for demographic determination using the present principles.

FIG. 2 shows one embodiment of an apparatus for demographic determination using the present principles.

FIG. 3 shows one embodiment of a profiler under the present principles.

FIG. 4 shows one embodiment of a classifier under the present principles.

### DETAILED DESCRIPTION OF THE INVENTION

The principles described herein are directed to a method and apparatus for generating demographic information based on user ratings. These principles provide a novel approach to leverage matrix factorization (MF) as the basis for an inference method of private attributes using item ratings.

The described principles propose a novel classification method for determining a user's binary private attribute, her type, based upon ratings alone. In particular, the principles use matrix factorization to learn item profiles and type-dependent biases, and show how to incorporate this information into a classification algorithm. This classification method is consistent with the underlying assumptions employed by matrix factorization.

Earlier work in this area has used methods such as Naïve Bayes or linear regression, for example. The advantage of the present methods lies in properly weighing the importance of each movie, for example, in the decision making process by exploiting the purported linear relationship between ratings and profiles for both users and movies.

At least one embodiment of this method and apparatus allows the system to infer a user's demographic information (for example, gender, age, etc.) from the ratings that they have given to a set of items, such as movies, restaurants, etc.

An exemplary embodiment of a demographic generation system using the described principles will now be described in the context of a system for determining demographic information for at least one user relative to a training set comprising movies. However, it is understood that the present principles apply equally to training sets comprising other items that may possess associated ratings.

The system may use, for example, a database of ratings to profile movies. The ratings have been generated by users whose demographics are known. The recommendation system, with access to the dataset of ratings and demographics of the raters, computes a set of item profiles as well as a set of type-dependent biases, for example, by minimization using gradient descent. The type-dependent biases are the latent factors obtained through matrix factorization. A new user arrives in the system and submits ratings for at least some items in the dataset, but does not submit her demographics. When this new user of unknown demographic information provides her ratings, the system uses the profiles of the movies she has rated to infer demographic information, for example, her gender, using a classifier.

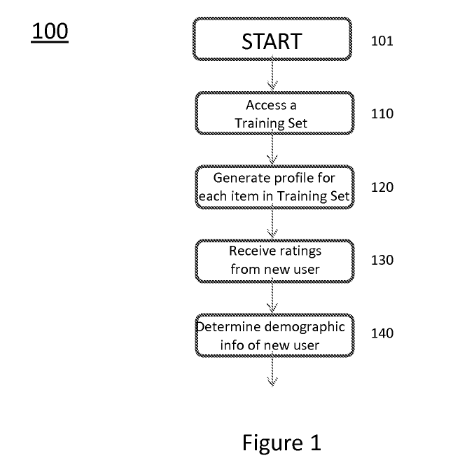

One embodiment of a method 100 for determining demographic information of a user under the present principles is shown in the flow diagram of FIG. 1. The method begins at start block 101 and control proceeds accessing a training set in block 110. The training set may be comprised of items that users provide ratings for, user identifications for those ratings and the ratings themselves. The training set may also comprise demographic information associated with those users whose ratings comprise the training set. Following block 110, control proceeds to block 120 for generating profile information for items in the training set. This block may comprise generating such profile information for every item within the training set, or for a subset of the training set. The method continues with control proceeding to block 130 for receiving ratings for at least one item included in the training set from at least one new user. Control proceeds to block 140 for determining demographic information for the at least one new user. The determination of demographic information in block 140 may be performed by solving a set of optimization problems, or alternatively, if the demographic information is associated with a single bit, with a maximum likelihood bit estimation under an appropriate generative model.

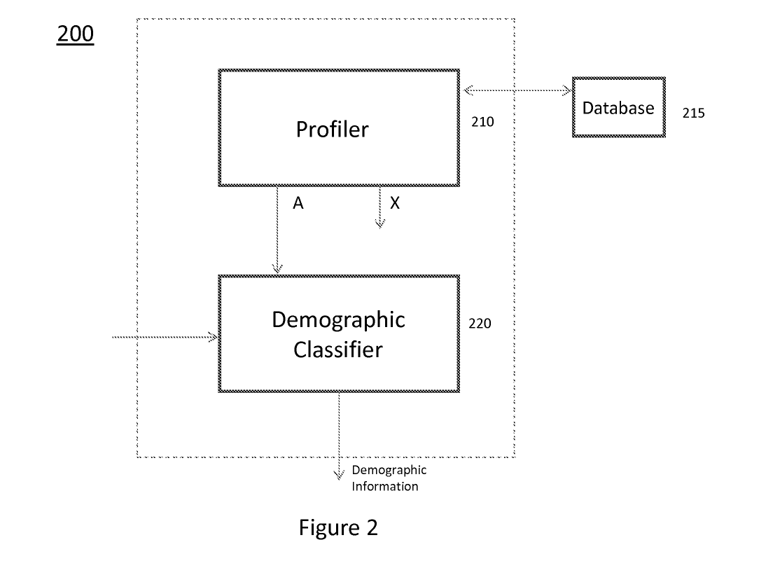

One embodiment of an apparatus 200 for determining demographic information of at least one user under the present principles is shown in FIG. 2. The apparatus 200 may be comprised of one or more processors configured to implement the functions described, or the functional elements can be standalone or integrated units. The apparatus is comprised of a Profiler 210 that accesses a training set that may be comprised of items that users provide ratings for, user identifications for those ratings and the ratings themselves. The training set also comprises demographic information associated with those users whose ratings comprise the training set. The training set may be contained external to apparatus 200, such as in Database 215, or contained within apparatus 200.

Profiler 210 may have access to a database of user ratings that are provided for a set of movies, for example, termed henceforth the “training dataset”. The profiler generates movie profiles through a matrix factorization technique, for example. Profiles such as these may be vectors that capture features of the movies, including the effect of a user's demographic on the movie's rating. Other techniques may be used other than matrix factorization for this purpose.

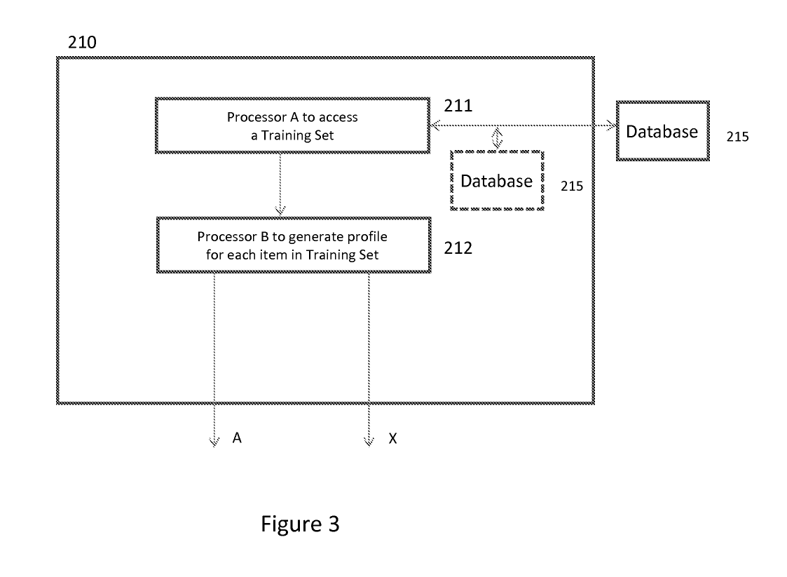

Apparatus 200 also comprises a Classifier 220. Classifier (220) may receive as input the movie profiles, for example, output by the Profiler. It uses this information to classify new users (not in the training dataset) with respect to their demographic information. A first input to Classifier 220 is in signal communication with a first output, A, of Profiler 210. Output A of Profiler 210 represents profiles of the items in the training set. A second output of Profiler 210, X, represents profiles of users that have provided ratings for items in the training set. A second input to Classifier 220 receives at least one rating on at least one of the items in the training set from at least one new user. Classifier 220 operates on profiles received from Profiler 210 and on ratings from at least one new user to generate demographic information for the at least one new user on its output. One embodiment of the Profiler 210 of FIG. 2 is shown in FIG. 3. FIG. 3 shows Profiler 210 comprising separate processors A and B. Processor A 211 functions to access a training set, such as in Database 215. Database 215 may be external to Profiler 210 or Profiler 210 can also comprise the database, as shown in a dashed outline in FIG. 3. Database 215 may also be external to apparatus 200. Database 215 contains a training set as described previously.

Processor A 211 communicates with Processor B 212. Processor B 212 generates profile information for each item in the training set and outputs a profile vector A and demographic information X of users who have provided the ratings contained in the database 215. Profile vector A is sent to the Classifier 220.

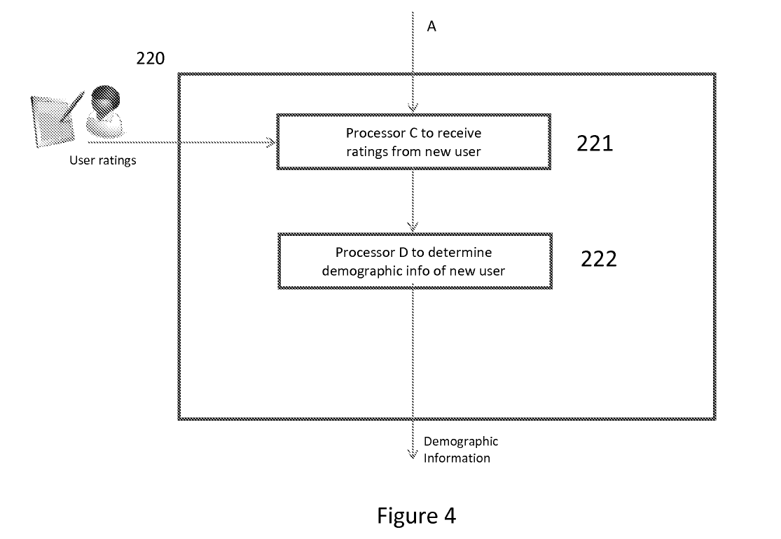

One embodiment of Classifier 220 from FIG. 2 is shown in FIG. 4. Processor C 221 of Classifier 220 receives profile vector A from Profiler 210. A second input to Classifier 220 comprises user ratings on at least one item contained in the training set from at least one user. The user is typically one whose ratings are not already contained within the training set. Processor C 221 may receive these ratings or the ratings may be sent to Processor D 222. Processor C 221 communicates with Processor D 222 to send information regarding the profile matrix A and/or the user ratings. Processor D 222 uses this information to determine demographic information of the new user as an output of Profiler 220 and apparatus 200.

One embodiment of the Profiler 210 of FIG. 2 is shown in FIG. 3. FIG. 3 shows Profiler 210 comprising separate processors A and B. Processor A 211 functions to access a training set, such as in Database 215. Database 215 may be external to Profiler 210 or Profiler 210 can also comprise the database, as shown in a dashed outline in FIG. 3. Database 215 may also be external to apparatus 200. Database 215 contains a training set as described previously.

Processor A 211 communicates with Processor B 212. Processor B 212 generates profile information for each item in the training set and outputs a profile matrix A and demographic information X of users who have provided the ratings contained in the database 215. Profile matrix A is sent to the Classifier 220.

One embodiment of Classifier 220 from FIG. 2 is shown in FIG. 4. Processor C 221 of Classifier 220 receives profile matrix A from Profiler 210. A second input to Classifier 220 comprises user ratings on at least one item contained in the training set from at least one user. The user is typically one whose ratings are not already contained within the training set. Processor C 221 may receive these ratings or the ratings may be sent to Processor D 222. Processor C 221 communicates with Processor D 222 to send information regarding the profile matrix A and/or the user ratings. Processor D 222 uses this information to determine demographic information of the new user as an output of Profiler 220 and apparatus 200.

It should be understood that, although the previous embodiment showed four distinct processors and a distinct database, the invention as described may be implemented as standalone or integrated units in various configurations.

The training set accessible to the profiler in the movie profiling scenario may, for example, be comprised of tuples of the form (user_id, movie_id, rating), indicating the identifier of a user, the identifier of a movie, as well as the rating given to the movie movie_id by the user user_id. Ratings are given by the following bi-linear relationship

Tᵢⱼ=uᵢ^{T}ᵥⱼ+zⱼₜ+∈ᵢⱼ, (i,j)∈ε

where the third term is an independent Gaussian noise variable and the second term is a type bias, capturing the effect of a type on the item rating. Each user in the dataset is characterized by a categorical type, which captures demographic information such as gender, occupation, income category, etc. In the movie scenario, types are binary. The training set may also contain a table with the binary demographic information of each user in the dataset. This table may contain, e.g., tuples of the form (user_id, gender) or (user_id, political_affiliation), etc. The training set may comprise some other form or structure to associate a user with his/her demographic information. However, assume its structure is as described above for exemplary purposes. Assume demographic information that can be given a binary value, for example. For simplicity we assume throughout that each user i has a binary value bᵢ∈{−1, +1} characterizing, for example, her gender.

The profiler generates a profile vⱼ=[vⱼ₀, vⱼ₁, . . . , v_{jd}]∈R^{d+1}, of dimension d+1, for each movie j in the training dataset. This profile is a latent vector, computed mathematically using training data of the user ratings, but not directly explainable simply in terms of real-world characteristics of the movie. The profiler generates the profile by solving the following optimization problem, also known as matrix factorization (MF)

$$Minimize {\sum }_{( i , j ) ∈ D} {( {r}_{ij} - {\sum }_{k = 1}^{d} {v}_{jk} {u}_{jk} - {v}_{j 0} {b}_{i} )}^{2} + λ {\sum }_{i} {‖ {u}_{i} ‖}^{2} + λ {\sum }_{j} {‖ {v}_{j} ‖}^{2} \qquad ( 1 )$$

(Unknowns vⱼ₀, vⱼ₁, . . . , v_{jd} for all movies j, and uᵢ₁, . . . , u_{id} for all users i)

Formula (1) is the matrix factorization formula for binary characteristics. In the above formula, D is the set of pairs (user_id, movie_id) present in the training dataset, rᵢⱼ is the rating given by user i to movie j in the dataset, bᵢ is the bit of user i (+1 or −1) and uᵢ=[uᵢ₁, . . . u_{id}]∈R^{d} is an unknown user profile. The last two terms of (1) are called the regularization terms. In practice, they are introduced to avoid overfitting. The regularization terms are the l₂-norm of the user and movie vectors. Beyond the Bayesian perspective, another motivation behind the introduction of such terms is the prior belief that the model ought to be simple; the regularization terms penalize the complexity of the parametrized model (through the penalty on the l₂-norms of profiles). As such, they act as “Occam's razor”, favoring parsimonious or simpler models over models that better fit the observed data. The Bayesian point of view also agrees with this intuition, as the Gaussian priors indeed bias the parameter selection to profiles with small norm.

The above problem can be solved to obtain the user and movie profiles through techniques such as, for example, gradient descent or alternating minimization. In an alternative embodiment of the movie profiler, additional regularization terms may be added to the MF problem. Also, in an alternative embodiment of the movie profiler, the unknowns vⱼ₀ may be fixed prior to solving (1) to vⱼ₀=mⱼ₊−mⱼ₋, where mⱼ₊ and mⱼ₋ the average rating to item j among users with bᵢ=+1 and bᵢ=−1, respectively.

Intuitively, the profiler characterizes how different aspects of the movie affect the rating that a user gives to this movie, concisely incorporating the effect of the demographic information through a corresponding component in the output profile.

The Classifier (220), armed with these profiles, and upon receiving the ratings a user gave to some movies in the original training set, tries to “explain” these ratings the best it can, by “fitting” a user profile to the movie profiles for each movie rated. The computed profile attributes have a component that corresponds to the demographic; the classifier's decision on how to label the user is based on this value.

Upon constructing the movie profiles vⱼ the profiler provides them to the classifier (the user profiles need not be used). Then, when a new user shows up and provides her ratings to the classifier, the classifier determines a particular bit representative of a classifier demographic in the following way: Given ratings rⱼ by the user for a subset A of all movies in D, the classifier solves the optimization problems (for the binary case):

$$min f ( u , + 1 ) = {\sum }_{j ∈ A} {( {r}_{j} - {\sum }_{k = 1}^{d} {v}_{jk} {u}_{k} - {v}_{j 0} )}^{2} + λ {\sum }_{i} {‖ u ‖}^{2} \\ and \\ min f ( u , - 1 ) = {\sum }_{j ∈ A} {( {r}_{j} - {\sum }_{k = 1}^{d} {v}_{jk} {u}_{k} + {v}_{ j 0} )}^{2} + λ {\sum }_{i} {‖ u ‖}^{2} \qquad ( 2 )$$

w.r.t. unknowns u=[u₁, . . . , u_{d}] ∈ R^{d}. Let u₊ be the optimal solution to the first problem and u₋ the optimal solution to the second problem (which again can be computed in closed form in terms of the vⱼ's and the rⱼ's). The classifier predicts the bit that is representative of the classifier demographic to be +1 if f(u₊,+1)<f(u₋,−1) and −1 otherwise. We note that the classification implied by this method is the maximum likelihood bit estimator under an appropriate generative model. In addition, the classification can be computed quickly without solving the above optimization problems through the formula:

$$b = \{ \begin{matrix}+ 1 & if {v}_{A 0}^{T} ( I - {{V}_{A} ( λ I + {V}_{A}^{T} {V}_{A} )}^{- 1} {V}_{A}^{T} ) {r}_{A} \geq 0 \\ - 1 & o . w .\end{matrix} \qquad ( 3 )$$

where v_{A0} is the vector of all biases of movies in A, V_{A} is the matrix of movie profiles in A excluding V_{A0}, and r_{A} is the vector of ratings for movies in A.

The methods described herein can be extended to multi-classification problems, such as when a particular piece of demographic information has more than two possibilities of a binary case (e.g., determining the age of a user) through methods such as one-vs-many classification, and binarizing the multiple categories, for example.

In an alternate embodiment, the objectives above can be altered to provide different weights to different movies based on the variance of the ratings they receive.

One or more implementations having particular features and aspects of the presently preferred embodiments of the invention have been provided. However, features and aspects of described implementations can also be adapted for other implementations. For example, these implementations and features can be used in the context of other video devices or systems. The implementations and features need not be used in a standard.

Reference in the specification to “one embodiment” or “an embodiment” or “one implementation” or “an implementation” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

The implementations described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or computer software program). An apparatus can be implemented in, for example, appropriate hardware, software, and firmware. The methods can be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein can be embodied in a variety of different equipment or applications. Examples of such equipment include a web server, a laptop, a personal computer, a cell phone, a PDA, and other communication devices. As should be clear, the equipment can be mobile and even installed in a mobile vehicle.

Additionally, the methods can be implemented by instructions being performed by a processor, and such instructions (and/or data values produced by an implementation) can be stored on a processor-readable medium such as, for example, an integrated circuit, a software carrier or other storage device such as, for example, a hard disk, a compact disc, a random access memory (“RAM”), or a read-only memory (“ROM”). The instructions can form an application program tangibly embodied on a processor-readable medium. Instructions can be, for example, in hardware, firmware, software, or a combination. Instructions can be found in, for example, an operating system, a separate application, or a combination of the two. A processor can be characterized, therefore, as, for example, both a device configured to carry out a process and a device that includes a processor-readable medium (such as a storage device) having instructions for carrying out a process. Further, a processor-readable medium can store, in addition to or in lieu of instructions, data values produced by an implementation.

As will be evident to one of skill in the art, implementations can use all or part of the approaches described herein. The implementations can include, for example, instructions for performing a method, or data produced by one of the described embodiments.

A number of implementations have been described. Nevertheless, it will be understood that various modifications can be made. For example, elements of different implementations can be combined, supplemented, modified, or removed to produce other implementations. Additionally, one of ordinary skill will understand that other structures and processes can be substituted for those disclosed and the resulting implementations will perform at least substantially the same function(s), in at least substantially the same way(s), to achieve at least substantially the same result(s) as the implementations disclosed. Accordingly, these and other implementations are contemplated by this disclosure and are within the scope of these principles.

1. A method for determining demographic information of a user, comprising:
accessing information in a set;
generating a profile matrix by matrix factorization for each of a plurality of items in the set relating to demographic information;
receiving at least one rating said user has assigned to at least one of the plurality of items in said set; and,
finding a solution to a system of linear equations based on the at least one rating from said user and said profile matrix to generate demographic information regarding the user.

2. The method of claim 1, wherein said information comprises an identifier associated with each item in the set, a rating for each of said items, an identifier that associates each of said ratings with a rater, and demographic information associated with each said rater.

3. The method of claim 1, wherein said plurality of items are movies.

4. An apparatus, comprising:
one or more processors for determining demographic information of a user, collectively configured to:
access information in a set;
generate a profile matrix by matrix factorization for each of a plurality of items in the set relating to demographic information;
receive at least one rating said user has assigned to at least one of the plurality of items in said set; and
find a solution to a system of linear equations based on the at least one rating from said user and said profile matrix to generate demographic information regarding the user.

5. The apparatus of claim 4, wherein said information comprises an identifier associated with each item in the set, a rating for each of said items, an identifier that associates each of said ratings with a rater, and demographic information associated with each said rater.

6. The apparatus of claim 4, wherein said plurality of items are movies.
